(19) United States
(12) Patent Application Publication
(10) Pub. No.: US 2007/0007780 A1
(43) Pub. Date: Jan. 11, 2007

(54) Kinetic energy absorber, particularly for large mobile objects

(76) Inventors: Lucjan Lagiewka, Kowary (PL); Marian Witalis Dobry, Poznam (PL)

Correspondence Address: WILLIAM COLLARD;COLLARD & ROE, P.C., 1077 NORTHERN BOULEVARD, ROSLYN, NY, 11576, US

(21) Appl. No.: 10/570,095

(22) PCT Filed: Dec. 5, 2003
(86) PCT No.: PCT/PL03/00134

§ 371 Date: Mar. 1, 2006

(30) Foreign Application Priority Data
Dec. 9, 2002 (PL) P.357620

(51) Int. Cl. B60R 19/26

(52) U.S. Cl. 293/132

(57) ABSTRACT

The invention is related to a kinetic energy absorber, particularly useful for large mobile objects, applicable as a bumper in cars, elevators, rail-cars, quays and other objects susceptible to the effects of sudden collisions. It is characterized by the use of a rotor (4) connected to a bumper (6) through a multiplying gear (2).

The invention is a kinetic energy absorber, particularly for large mobile objects, applicable as a bumper in cars, elevators, rail cars, quays and other objects susceptible to the effects of sudden collisions.

Kinetic energy absorbers known so far, which are used to protect cars against the effects of a potential collision with a fixed obstruction, are bumpers with a controlled crushing zone. In such cases, the absorbed kinetic energy is converted into energy required to deform car's structure.

Kinetic energy absorbers used in rail cars are helical dumper springs or elastomer filler inside the bumpers. In this solution, the absorbed energy is gradually transformed during a collision into potential energy of absorbers' elasticity and released afterwards leading to the rebound.

The primary feature of the invention (the kinetic energy absorber, applicable particularly to large mobile objects) is that it comprises a rotor connected to a bumper via multiplying gear.

The efficiency is increased when the multiplying gear is connected to the bumper by means of a toothed bar.

The effect is also intensified if the toothed bar and the bumper are separated with an elastic element.

Another advantage is achieved when the multiplying gear has the form of a toothed gear.

Thanks to the solutions proposed in this invention, it is possible to achieve almost total conversion of objects' translational energy into rotor's rotational energy.

When applied to various mobile objects the solution protects them from damage and keeps the passengers safe from injuries or, in extreme cases, even save lives. Items located inside the object are secured as well. Rebound from an obstruction has also been eliminated.

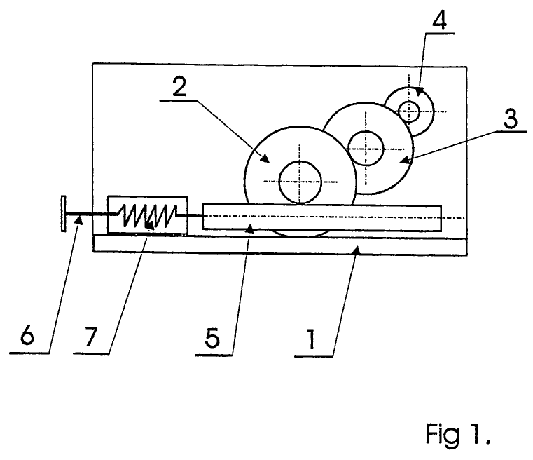

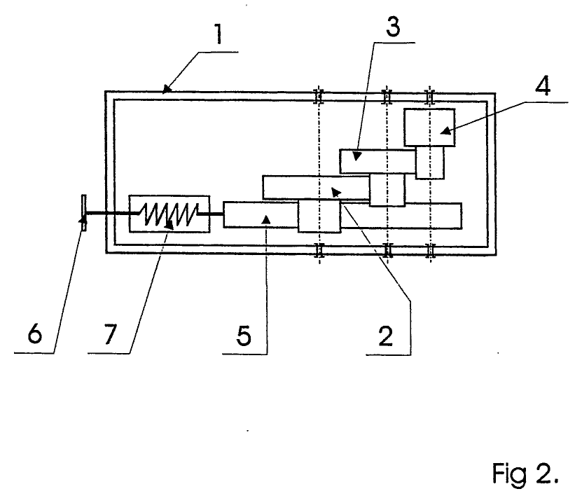

FIG. 1 represents a side view of the invention's sample embodiment and FIG. 2 is a top view of the same.

The multiplying gear (2) meshed with the gear wheel (3) propelling the rotor (4) is installed on a frame (1) which is fixed to the potentially colliding object.

The multiplying gear (2) is meshed with the toothed bar (5) fixed to the frame in such a way that it is free to slide along (1). The toothed bar (5) is equipped with a bumper at least from one side.

In some variations of the invention, the toothed bar (5) is connected to a bumper through an elastic element (7). In other variations the toothed bar is equipped with a bumper (6) on both sides.

Yet in other variations, the multiplying gear (2) is propelled by a system of pulling rods.

An object in a translational motion has kinetic energy which is used for deformation of the object during a collision with a fixed rigid obstacle.

In the case of the presented solution, during obstacle's (not shown in the figure) interaction with the bumper (6), object's kinetic energy is transmitted to the toothed bar (5) and then through the multiplying gear (2) to the rotor (4) which makes it rotate.

In the course of this process, the kinetic energy of object's translational motion is converted into the rotational energy of the rotor.

In order to avoid damaging the multiplying gear (2), an elastic element (7) should be mounted between the bumper and the toothed bar (5).

During tests, the presented absorber was used as a car bumper. Normally in the case of a collision with another car or a fixed; rigid obstacle, such as a tree or a wall, the kinetic energy of a car is converted into deformation energy of the car's crashing zone.

The absorber used makes it possible to slow the vehicle down to zero without any structural deformation due to its quick energy conversion rate.

The vehicle alone contributes only partially to the total kinetic energy before the collision as the rest of it comes from the passengers and their luggage.

In another application, the absorber can be installed under elevator's floor or at the bottom of the shaft. In the case of emergency, such as snapped lifting rope, the kinetic energy of the falling cabin and its passengers, should be transformed into rotational energy of the rotor (4) without exerting any substantial force on the falling object.

The absorber can also be installed in rail cars' bumpers. When rail cars collide, being linked to the train, their kinetic energy is transformed into rotational energy of a rotor (4). It protects the cars and their load form damage. The protection works with a traveling train as well, eliminating all negative effects of kinetic forces.

Yet another possible application is to install the absorbers in the quays. It should eliminate the excessive forces that ships' sides exert on quay's walls, protecting thus the cargo from moving inside the hold.

Needles to say, the above examples are no more than an illustration of some among many possible uses for the invention.

1. A kinetic energy absorber, particularly for large mobile objects, unique due to the fact that it consists of a rotor (4) connected with a bumper (6) through a multiplying gear (2).

2. An absorber as claimed in claim 1, where the multiplying gear (2) is connected to the bumper (6) with a toothed bar (5).

3. An absorber as claimed in claim 2, where an elastic element (7) is installed between the bumper (6) and the toothed bar (5).

4. An absorber as claimed in claim 1, where the multiplying gear (2) is a toothed gear.
